(19) United States
(12) Patent Application Publication
(10) Pub. No.: US 2016/0184926 A1
(43) Pub. Date: Jun. 30, 2016

(54) LASER ABLATION SYSTEM INCLUDING VARIABLE ENERGY BEAM TO MINIMIZE ETCH-STOP MATERIAL DAMAGE

(71) Applicants: SUSS MicroTec Photonic Systems Inc., Corona, CA (US); International Business Machines Corporation, Armonk, NY (US)

(72) Inventors: Courtney T. Sheets, Santa Ana, CA (US); Matthew E. Souter, Tustin, CA (US); Brian M. Erwin, Lagrangeville, NY (US); Bouwe W. Leenstra, Walden, NY (US); Nicholas A. Polomoff, White Plains, NY (US); Christopher L. Tessler, Poughquag, NY (US)

(21) Appl. No.: 14/585,404

(22) Filed: Dec. 30, 2014

(51) Int. Cl. B23K 26/06; B23K 26/362; B23K 26/40; B23K 26/03

(52) U.S. Cl. CPC B23K 26/0626; B23K 26/032; B23K 26/362; B23K 26/40

(57) ABSTRACT

An ablation system includes an ablation tool configured to generate an energy beam to ablate an energy-sensitive material formed on at least one embedded feature of a workpiece. The ablation tool selects an initial fluence and an initial pulse rate of the energy beam to ablate a first portion of the energy-sensitive layer. The ablation tool further reduces at least one of the initial fluence and the initial pulse rate of the energy beam to ablate a second remaining portion of the energy-sensitive layer such that the embedded feature is exposed without being damaged or deformed.

### BACKGROUND

The present disclosure relates generally to energy ablation techniques, and more specifically, to a laser ablation system configured to adjust the power of a laser beam to control ablation levels.

Various materials such as, for example, semiconductor and/or etching materials, can be etched using laser ablation tools configured to generate high-energy and/or rapid-repetition laser pulses that form one or more features in the workpiece. Conventional laser-based ablation processes often utilize an etch-stop layer that protects an underlying layer from exposure to the laser pulses. During the ablation process however, the fluence delivered by the laser beam may overexpose area portion of the etch-stop layer.

Turning to FIGS. 1A-1B, for example, a workpiece 10 is illustrated following a laser ablation process. The workpiece 10 includes an etch-stop layer 12 interposed between a laser-sensitive layer 14 and an underlying layer 16. The laser-sensitive layer 14 has a trench 18 formed therein as further illustrated in FIG. 1A. The trench 18 exposes the etch-stop layer 12, which limits the etching processes and protects the underlying layer 16 during the laser ablation process. The laser fluence may inadvertently become concentrated at a particular area such as for example, a corner area 20, of the laser-sensitive layer 14 during laser ablation process. Fluence reflected off the side wall of laser-sensitive layer 14 can lead to an increase in the concentration of laser fluence which overexposes and thus heats the particular concentration area 20, which can cause the material of etch-stop layer 12 to reflow, recrystallize and deform. Consequently, the trench 18 is formed with a desired diameter, e.g., approximately 45 micrometers (μm), while the etch-stop layer 12 is altered to include an undesirable deformed portion 22. In this case, for example, the deformed portion 22 is formed as a cavity that extends below the surrounding portions of the etch-stop layer 12 (see FIG. 1B). The deformed portion 22 causes the edge of the laser-sensitive layer 14 to descend into the cavity, thereby creating unintended tension in the laser-sensitive layer 14 and increased steepness in the side wall of the etched opening which could complicate future processing steps.

It is desirable to operate the laser ablation tool at maximum throughput. Current methods of increasing throughput include increasing the power delivered to the workpiece. An additional reason increased laser power may be called for is to guarantee that etched features are fully opened in a laser-sensitive layer that may vary in thickness and composition. As described above, however, the increased power can over expose and thus deform the etch-stop layer, for example. Current methods to reduce damage to and deformation of the etch-stop layer include using particular etch-stop materials and/or increasing the thickness of the etch-stop material to withstand higher energy throughputs. These methods, however, limit the workpiece to particular design applications and typically increase the overall cost of the workpiece.

### SUMMARY

According to at least one embodiment of the present invention, an ablation system includes an ablation tool configured to generate an energy beam to ablate an energy-sensitive material formed on at least one embedded feature of a workpiece. The ablation tool selects an initial fluence and an initial pulse rate of the energy beam to ablate a first portion of the energy-sensitive layer. The ablation tool further reduces at least one of the initial fluence and the initial pulse rate of the energy beam to ablate a second remaining portion of the energy-sensitive layer such that the embedded feature is exposed without being damaged or deformed.

According to another embodiment, a method of ablating an energy-sensitive layer formed on at least one embedded feature of a workpiece comprises directing an energy beam generated by an ablation tool to the energy-sensitive layer, the energy beam having an initial fluence and an initial pulse rate. The method further comprises ablating a first portion of the energy-sensitive layer according to at least one of the initial fluence and the initial pulse rate of the energy beam. The method further comprises reducing at least one of the initial fluence and the initial pulse rate of the energy beam. The method further comprises ablating a second remaining portion of the energy-sensitive layer according to at least one of the reduced fluence and the reduced pulse rate of the energy beam such that the at least one embedded feature is exposed without being damaged or deformed.

According still another embodiment, a method of ablating an energy-sensitive layer formed on at least one embedded feature of a workpiece comprises generating an energy beam using an ablation tool. The energy beam includes a first fluence portion having a first fluence level and a second fluence portion having a second fluence level. The method further includes scanning the energy beam across the energy-sensitive layer. The first fluence portion ablates the energy-sensitive material to a first depth and the second fluence portion ablates a second remaining portion of the energy-sensitive layer such that the at least one embedded feature is exposed without being damaged or deformed

Additional features are realized through the techniques of the present invention. Other embodiments are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing features are apparent from the following detailed description taken in conjunction with the accompanying drawings in which:

FIG. 1A illustrates a cross-section of a workpiece following a conventional laser ablation process;

FIG. 1B is a close-up view of a deformed portion of an etch-stop layer included in the workpiece caused by the conventional laser ablation process;

FIG. 2A illustrates a top-view of a laser ablation system prior to applying a laser beam having a first power level on a laser-sensitive layer of a workpiece according to a first embodiment;

FIG. 2B illustrates a side-view of the laser beam and workpiece shown in FIG. 2A according to the first embodiment;

FIG. 2C illustrates the side-view of the laser beam shown in FIG. 2B after scanning the workpiece along a first scanning direction to perform a first ablation of a portion of the laser-sensitive layer according to the first embodiment;

FIG. 2D illustrates a top-view of the laser ablation system shown in FIGS. 2A-2C before performing a second pass of the laser beam having a decreased power level on the first ablated portion of the laser-sensitive layer along a second direction of the workpiece according to the first embodiment;

FIG. 2E illustrates the side-view of the laser beam shown in FIG. 2D after scanning the workpiece along the second scanning direction to completely ablate the laser-sensitive layer according to the first embodiment;

FIG. 3 is a flow diagram illustrating a method of ablating a workpiece according to a non-limiting embodiment;

FIG. 4 is a flow diagram illustrating another method of ablating a workpiece according to a non-limiting embodiment;

FIG. 5A illustrates a top-view of a laser ablation system prior to scanning a laser beam including a first fluence portion and a second fluence portion across an energy-sensitive layer of a work piece according to a second embodiment;

FIG. 5B is a side view illustrating a side profile of the laser beam generated by the laser ablation system illustrated in FIG. 5A;

FIG. 5C is a top view of the laser ablation system shown in FIGS. 5A-5B following ablation of the energy-sensitive layer; and

FIGS. 6A-6B illustrate an ablation system configured to perform a full-scale ablation on workpiece in response to varying the pulse rate of a laser beam according to a third embodiment.

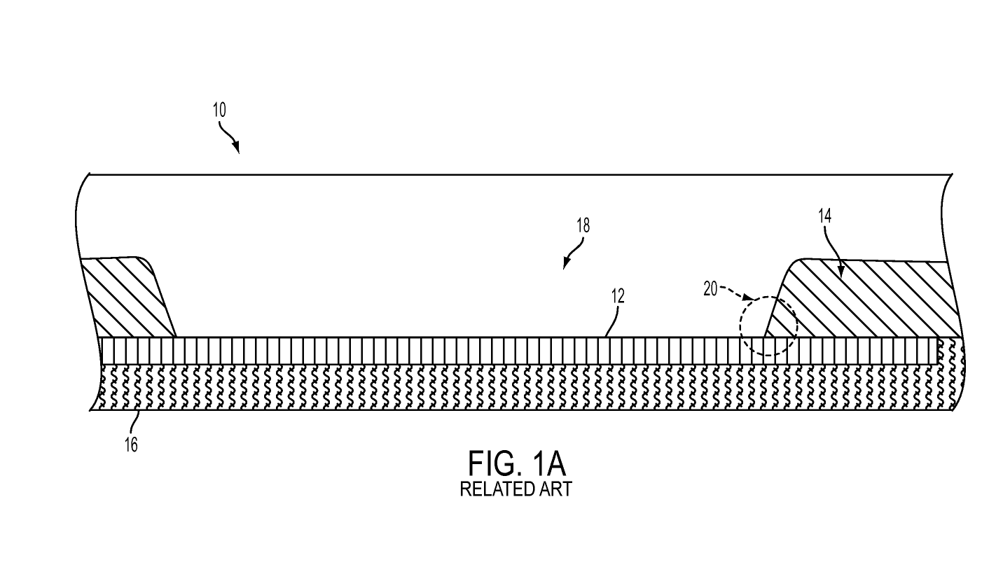

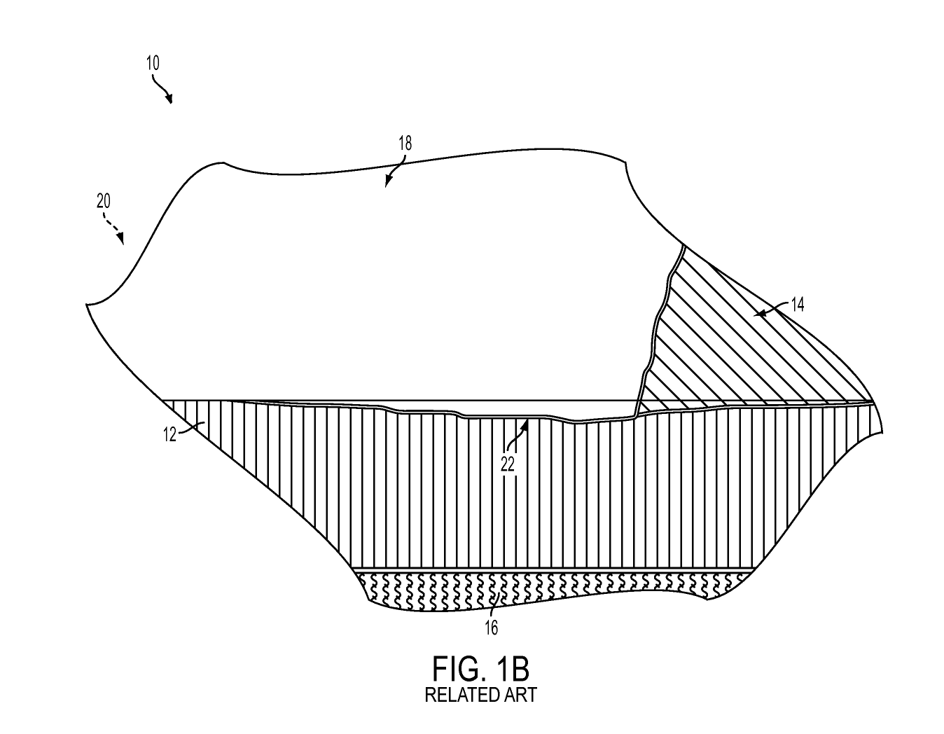

### DETAILED DESCRIPTION

Conventional laser ablation systems generate a laser beam at a single wavelength, fluence, pulse duration, and pulse rate when performing a laser ablation process to ablate a laser-sensitive material of a workpiece. Consequently, fluences and/or pulse rates can typically be increased in order to increase laser throughput when emitted to the workpiece without precision and can ultimately deform and/or damage one or more embedded features such as, for example, an etch-stop layer formed beneath the laser-sensitive material. Contrary to conventional laser systems, various embodiments of the invention provide a laser-ablation system configured to adjust the pulse rate and/or fluence of a laser beam when performing a laser ablation process. In this manner, the laser ablation process can be controlled to mitigate deformation of the embedded features (e.g., the etch-stop layer).

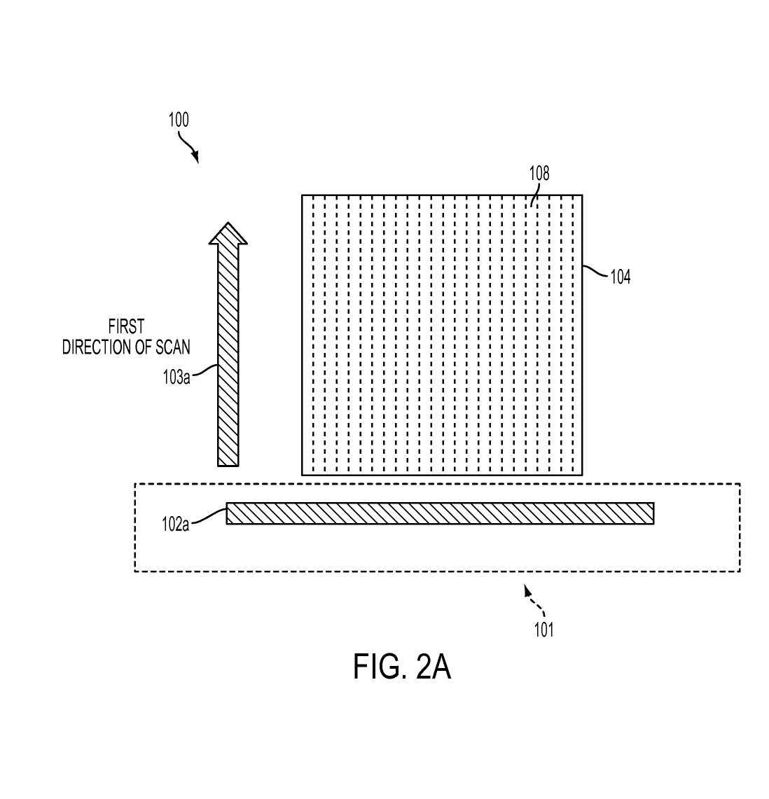

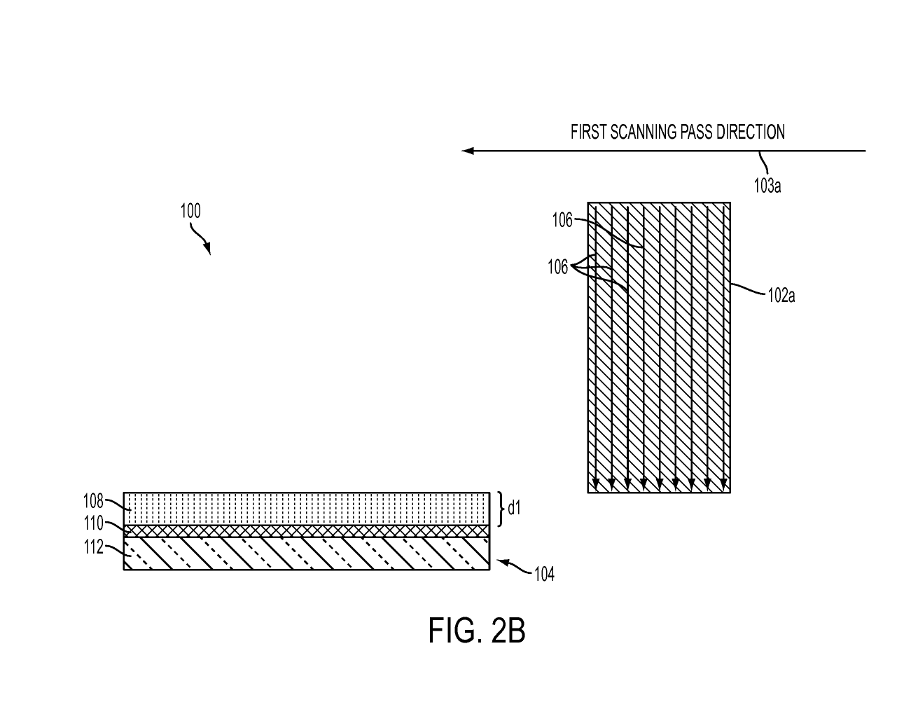

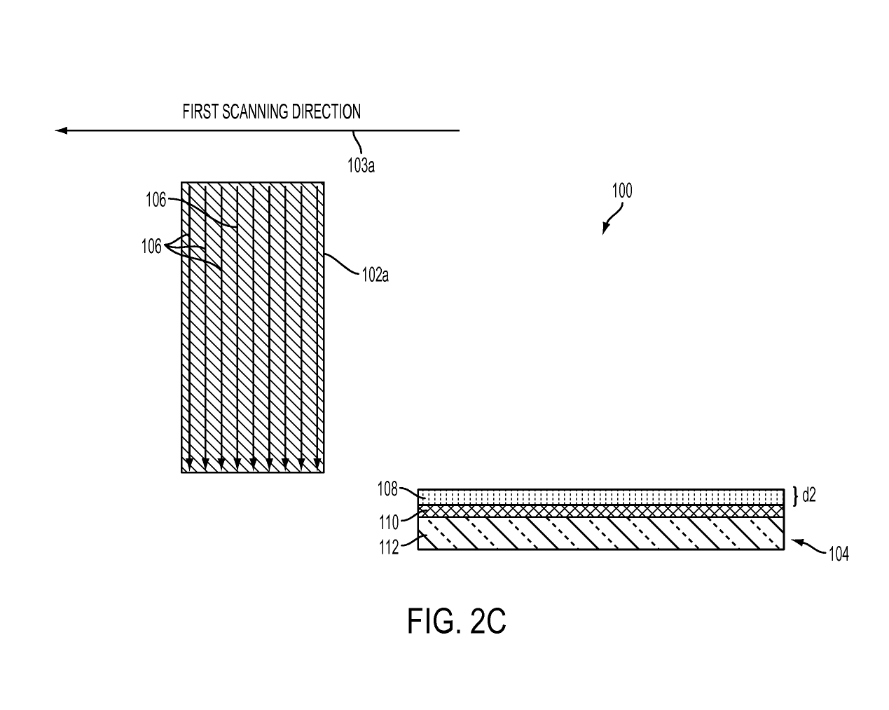

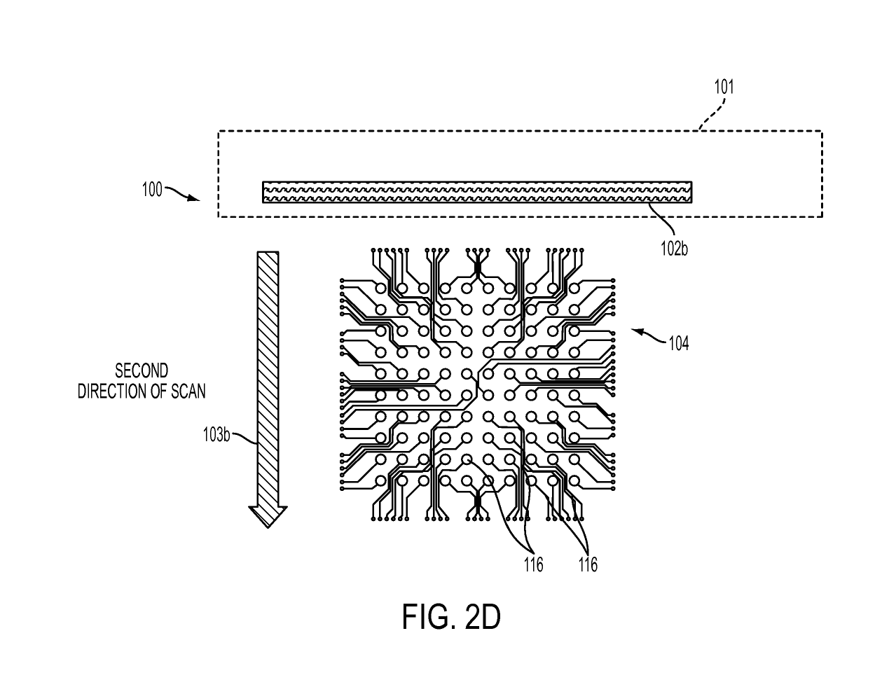

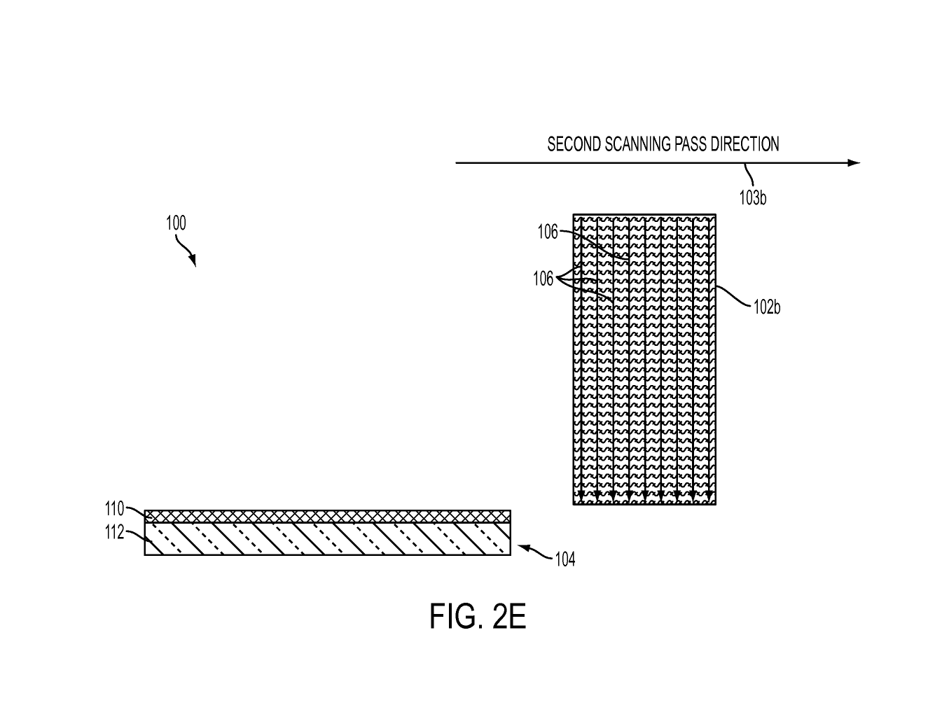

Turning now to FIGS. 2A-2B, an ablation system 100 is illustrated according to a first non-limiting embodiment. The ablation system 100 includes an ablation tool 101 that generates an energy beam 102a. According to a non-limiting embodiment, the ablation tool is a laser ablation tool that generates a first laser beam 102a. Prior to scanning a workpiece 104 (i.e., workpiece), the first laser beam 102a is generated (i.e., power, wavelength, pulse duration, and pulse rate are defined) to deliver laser fluence (energy per unit area) 106 to the workpiece 104. During the scan of the workpiece, the beam may be altered (i.e., masked) by one or more masking layers, such that the resulting laser beam reaching the workpiece 104, may include areas which receive fluence (i.e., promote etching), while others do not receive fluence (i.e., remain un-etched). Unlike conventional ablation systems, the applied laser fluence 102a and/or pulse rate can be dynamically controlled when performing a laser ablation process to form one or features into a laser-sensitive layer 108 of the workpiece 104 as discussed in greater detail below. According to an embodiment, the initial applied laser fluence, initial laser width, initial laser pulse rate, initial scan velocity, and initial etch depth of the first laser beam 102a applied during a first pass (e.g., initial pass) is determined based on the user's ability to adjust these parameters and on an initial thickness and physical composition of the laser-sensitive layer 108.

The workpiece 104 includes an embedded feature 110 interposed between the laser-sensitive layer 108 and an underlying layer 112 as further illustrated in FIG. 2B. Although the embedded feature 110 is illustrated as an etch-stop layer, for example, it should be appreciated that the embedded feature 110 may include one or more features intended to maintain chemical and/or structural integrity while one or more portions of the laser-sensitive material are ablated. The embedded feature 110 may include, but is not limited to, metal layers, electrically conductive contact pads, electrically conductive vias, and barrier layers. The laser-sensitive layer 108 has an initial thickness (d1) and comprises various laser-sensitive materials including, for example, organic materials or a combination of organic and non-organic materials. The underlying layer 112 comprises any material desirable for a particular application such as, for example, silicon, silicon dioxide, etc.

Turning to FIG. 2C, the ablation system 100 is illustrated after performing a first scanning process that applied by the first pass of the laser beam 102a along a first scanning direction 103a. During the first scanning process, the first laser beam 102a ablates a portion of the laser-sensitive layer 108 according to the first pass applied laser fluence, laser width, laser pulse rate, and scan velocity of the first laser beam 102a. Accordingly, the initial thickness (d1) of the laser-sensitive layer 108 is decreased to a reduced thickness (d2). As discussed above, a first portion of the laser-sensitive layer 108 that is ablated during the first scanning process is based on the characteristics of the laser sensitive layer 108 including, for example, the initial thickness (d1) and the physical composition of the laser-sensitive layer 108. In this manner, the first portion of the laser-sensitive layer 108 can be ablated using a first high-laser fluence and/or high-pulse rate laser beam 102a, while a second portion 116 (i.e., remaining portion 116) of the laser-sensitivity layer 108 is left remaining to protect the embedded feature 110 from the high throughput of the first laser beam 102a, as discussed in greater detail below.

Turning now to FIG. 2D, the ablation system 100 generates a second laser beam 102b in preparation to perform a second scanning process included in the ablation process of the first embodiment. The second laser beam 102b, for example, has a second power. The second power is defined, for example, as a second energy level which can be created using a reduced fluence, reduced pulse rate, reduced laser width, and/or increased laser velocity to apply less total fluence 106 to the previously ablated portion formed in the laser-sensitive layer 108 of the workpiece 104. When the laser fluence and/or pulse rate are reduced, the ablation rate is slowed thereby reducing the buildup of heat and risk of damage to sensitive layers.

Referring to FIG. 2E, the ablation system 100 is illustrated after performing the second pass included in the scanning process which moves the second laser beam 102b along a second scanning direction 103b. The second scanning direction 103b is, for example, in a direction that is opposite the first scanning direction 103a. It should be appreciated, however, that the second scanning operation can be performed in the same direction as the first scanning operation. During the second scanning process, the second laser beam 102b ablates the remaining portion of the laser-sensitive layer (indicated as numeral 108 in FIG. 2D) according to the second applied energy level of the second laser beam 102b. Accordingly, the embedded feature 110 is exposed. The lower applied energy level, however, prevents the embedded feature 110 from becoming over-heated, damaged and/or deformed. Therefore, the chemical and structural integrity of the embedded feature 100 is maintained.

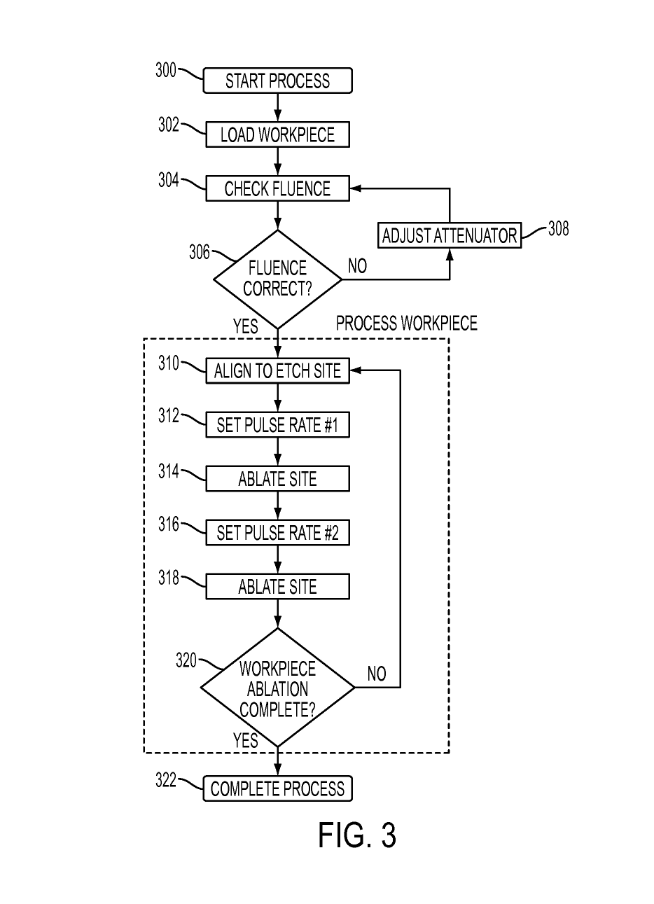

Turning to FIG. 3, a flow diagram illustrates a method of ablating a workpiece according to a non-limiting embodiment. The method begins at operation 300, and at operation 302 a workpiece including a laser-sensitive layer is loaded on a laser ablation tool. At operation 304, the initial fluence output by the laser tool is measured and at operation 306, a determination is made as to whether the initial laser fluence output is correct based on a number of parameters including the thickness and the physical composition of the laser-sensitive layer. When the fluence output is not correct (e.g., either too high or too low), an attenuator of the laser ablation tool can be adjusted at operation 308 to adjust the fluence output of the laser tool. When the fluence output is correct, an ablation process that varies the laser beam pulse rate is performed on the workpiece in operations 310-320.

For instance, the laser-sensitive layer of the workpiece is aligned with a laser beam output of the laser ablation tool at operation 310, and a first pulse rate at which to output the laser beam is set at operation 312. At operation 314, one or more sites of the laser-sensitive layer formed on the workpiece are ablated according to the set applied fluence, first pulse rate, initial laser width, and initial scan velocity. At operation 316, a second pulse rate at which to output the laser beam, a lower pulse rate for example, is set at operation 316. According to an embodiment, a time at which to set the second pulse rate can be set after performing a first laser scan across a desired area of the laser-sensitive layer to be ablated. According to another embodiment, the first pulse rate (e.g., initial pulse rate) can be set to the second pulse rate (e.g., lower pulse rate), after completing a predetermined number of pulses. At operation 320, a determination is made as to whether the ablation of the workpiece is complete. When further ablation is desired at different sites on the workpiece, the method returns to operation 310 and continues performing the ablation process according to operations 310-320. Otherwise, the method ends at operation 322.

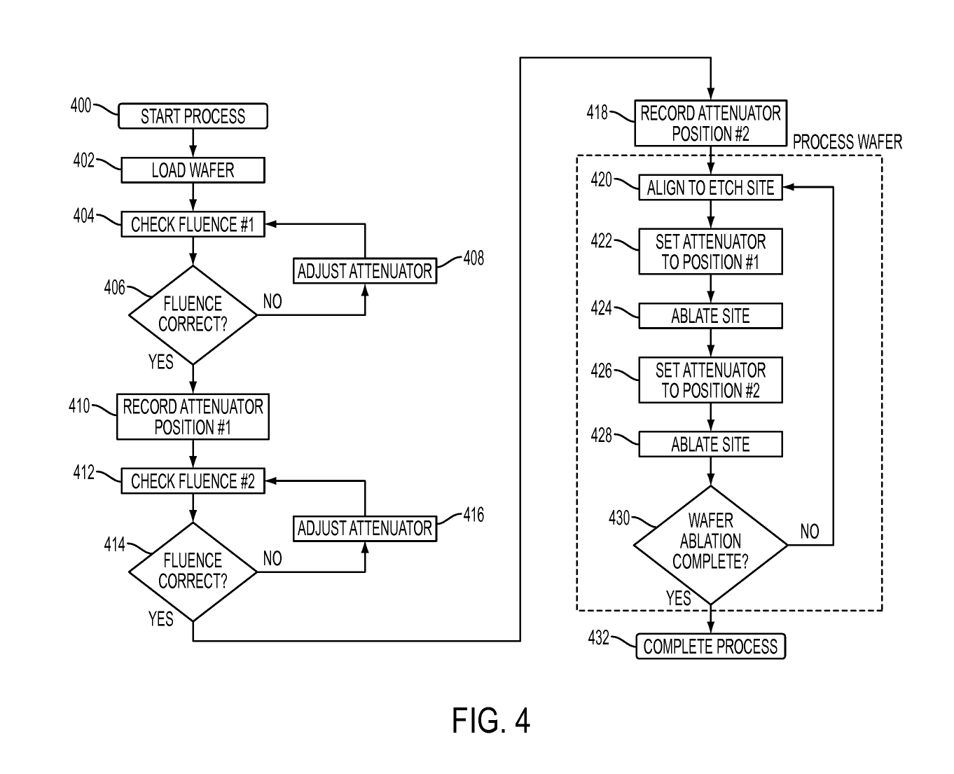

Referring to FIG. 4, a flow diagram illustrates a method of ablating a workpiece according to another non-limiting embodiment. The method begins at operation 400 and at operation 402 a workpiece including a laser-sensitive layer is loaded on a laser ablation tool. At operation 404, a first fluence output level of the laser tool (e.g., a fluence level of a laser beam) to be generated during a first laser scan is measured and at operation 406, a determination is made as to whether the first fluence output level is correct based on a number of parameters including the thickness and the physical composition of the laser-sensitive layer. When the fluence output level is not correct (e.g., either too high or too low), an attenuator of the laser ablation tool is adjusted at operation 408 to adjust the first fluence output of the laser tool. When the fluence output is correct, a first attenuator position of the attenuator is set (e.g., electrically stored in memory) at operation 410.

At operation 412, a second fluence output level of the laser tool to be generated during a second laser scan is measured and at operation 414, a determination is made as to whether the second fluence output level is correct based on a number of parameters including the remaining thickness and the physical composition of the laser-sensitive layer. When the fluence output level is not correct (e.g., either too high or too low), the attenuator of the laser ablation tool is adjusted at operation 416 to adjust the second fluence output level of the laser tool. When the second fluence output level is correct, a second attenuator position of the attenuator is set (e.g., electrically stored in memory) at operation 418, and an ablation process that varies the fluence of a laser beam is performed on the workpiece in operations 420-430.

For example, the laser-sensitive layer of the workpiece is aligned with a laser beam output of the laser ablation tool at operation 420, and the position of the attenuator is set according to the first attenuator setting at operation 422. The attenuator position can be set manually and/or automatically by an electronic controller (not shown) of the laser ablating tool. At operation 424, the laser-sensitive layer formed on the workpiece are ablated to a first depth according to inputs including the first applied fluence output level and a first pulse rate. In this manner, a portion of the laser-sensitive material having a reduced thickness is left remaining on an embedded feature of the workpiece.

At operation 426, the position of the attenuator is set according to the second attenuator setting, and the remaining portion of the laser-sensitive material is ablated at operation 428 thereby exposing the embedded features. At operation 430, a determination is made as to whether the ablation of the workpiece is complete. When further ablation is desired at different sites on the workpiece, the method returns to operation 420 and continues performing the ablation process according to operations 420-430. Otherwise, the method ends at operation 432. Although FIG. 4 illustrates an ablation process that varies the fluence, it should be appreciated that one or more operations of FIG. 3 may be incorporated into the embodiment illustrated in FIG. 4 to perform an ablation process that varies the pulse rate, the applied fluence of the laser beam, the laser width, scan velocity, and initial etch depth to ablate one or more portions of the workpiece while preventing deformation of one or more embedded features.

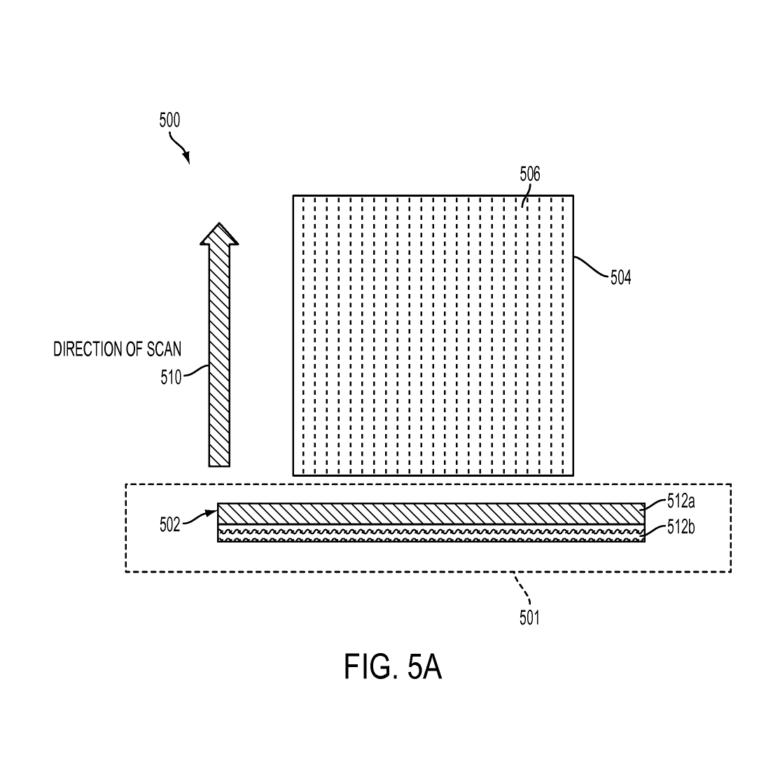

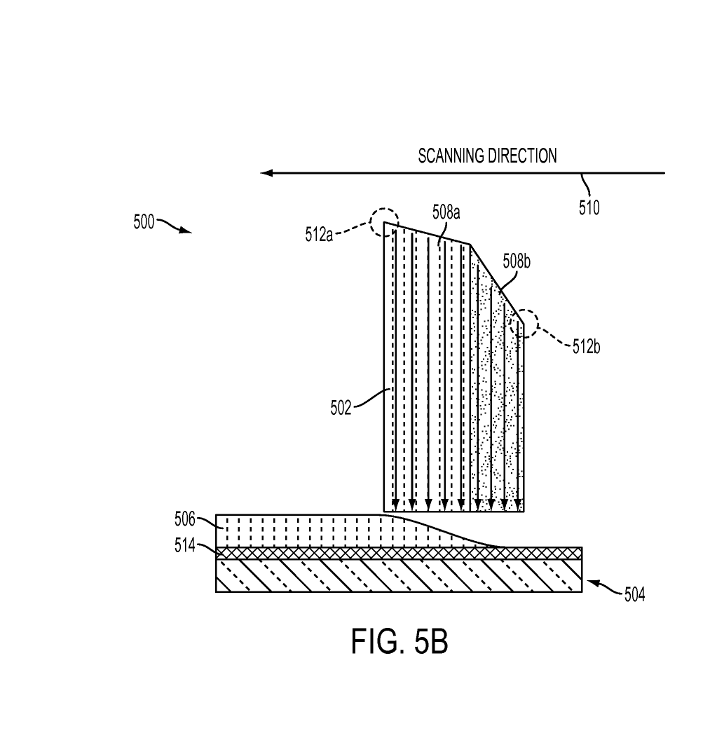

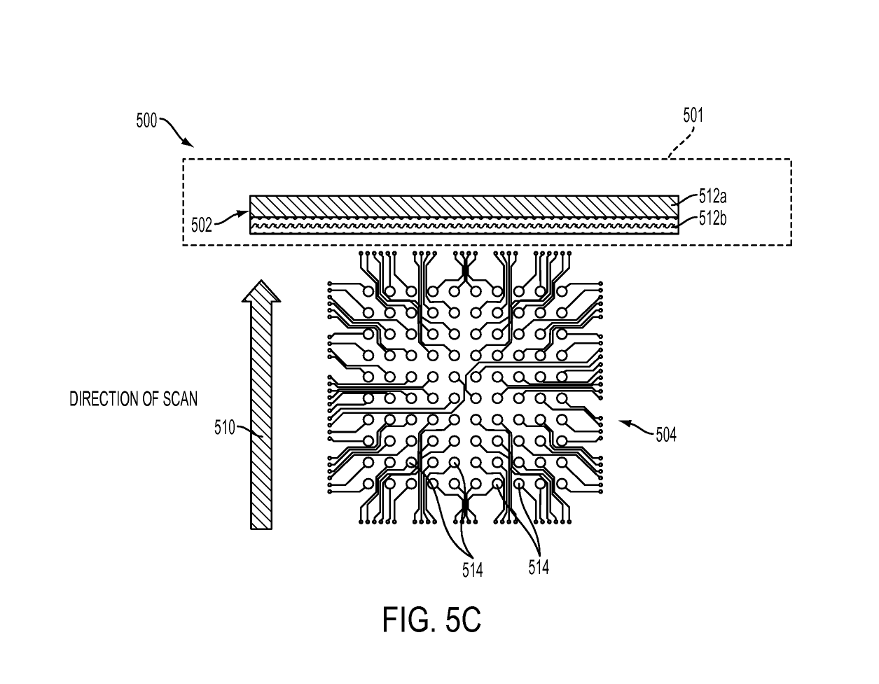

Turning now to FIGS. 5A-5C, an ablation system 500 is illustrated according to a second non-limiting embodiment. The ablation system 500 includes an ablation tool 501 that generates an energy beam 502 to form one or more features in a workpiece 504. According to a non-limiting embodiment, the ablation tool is a laser ablation tool that generates a laser beam 502 at a fixed pulse rate. During the scan of the workpiece, the beam may be altered (masked) by one or more masking layers, such that the resulting laser beam reaching the workpiece 104, may include areas which receive fluence (i.e., promote etching), while others do not receive fluence (i.e., remain un-etched). Unlike conventional ablation systems, the laser ablation system 500 ablates a laser-sensitive layer 506 of the workpiece 504 using a laser beam 502 having varying applied fluence. According to an embodiment, the laser beam 502 has a first fluence portion 508a and a second fluence portion 508b. The first fluence portion 508a provides a higher fluence level than the second fluence portion 508b. The first and second fluence portions 508a-508b (i.e., the variation in fluences) can be achieved by the internal optics of the ablation tool and/or one or more masks (not shown) interposed between the laser beam output of the ablation tool and the workpiece 504. In this manner, the laser beam 502 delivers two or more applied fluence levels to the laser-sensitive layer 506 during a single pass along the scanning direction 510.

With reference to the side-profile view of the laser beam 502 shown in FIG. 5B, the laser beam width that extends between a leading edge 512a and a trailing edge 512b. Various masks and/or optics can adjust the fluence that exists between the leading edge 512a and the trailing edge 512b. According to an embodiment, fluence level of the laser beam 502 decreases going from the leading edge 512a (i.e., the highest fluence) to the trailing edge 512b (the lowest fluence). In this manner, a first portion of the laser-sensitive layer 506 is ablated using the high fluence delivered by the first portion 512a, while the remaining portion of the laser sensitive layer 506 is ablated using the low fluence provided by the second portion 512b. Accordingly, the laser-sensitive layer 506 can be gradually ablated to expose one or more embedded features 514 using only a single pass of the laser beam 502 (see FIG. 5C) without causing deformation of the embedded features 514.

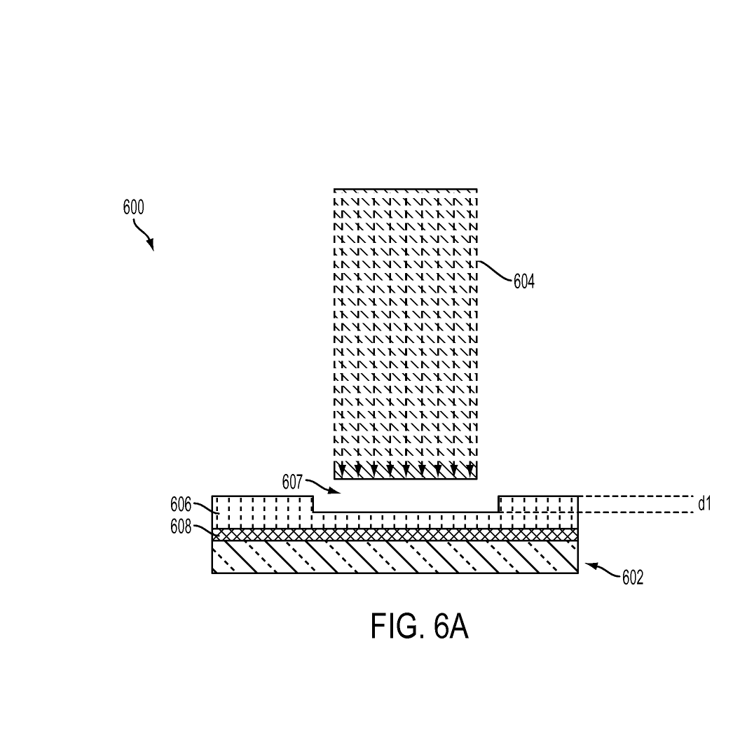

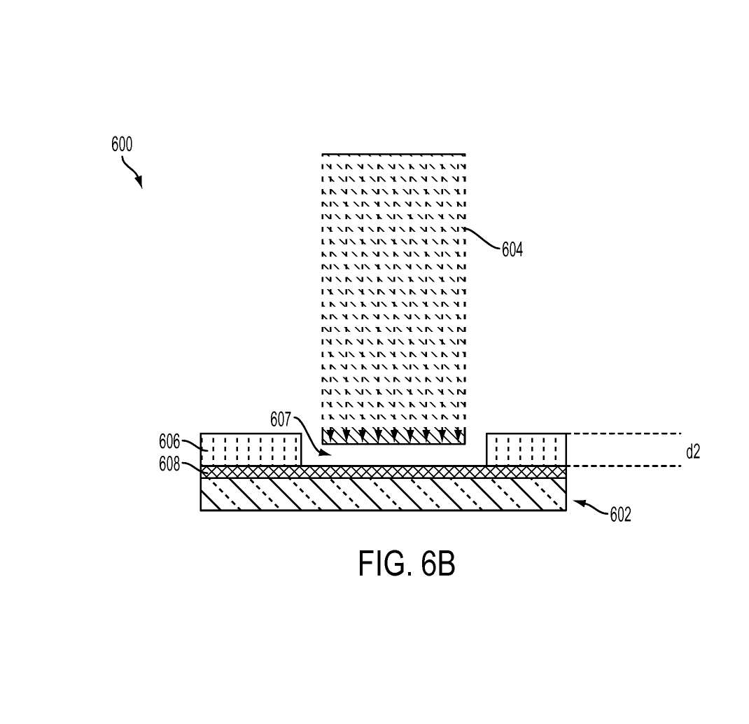

Referring to FIG. 6, an ablation system 600 configured to perform a full-scale ablation on workpiece 602 is illustrated according to a third non-limiting embodiment. In this embodiment, the laser is not scanned across the workpiece, but is instead directed at particular location of the workpiece. The ablation system 600 varies the pulse-rate of the laser beam 604 in response to a number of pulsed laser beams delivered to a laser-sensitive material 606 of the workpiece 602. As described above, the number of laser pulses required to ablate the laser-sensitive material 606 to a desired depth can be determined according to thickness and material of the laser-sensitive material 606. In this manner, the laser tool (not shown) can be set to a first pulse rate to form one or more features 607 having a first depth (d1) in the laser-sensitive material 606 as further illustrated in FIG. 6A. The laser ablation tool is configured to count the number of generated pulsed laser beams 604. Once the number of pulses occurs (i.e., the number of pulsed laser beams are generated), the laser ablation tool can automatically adjust the pulse rate to the second pulse rate (e.g., lower pulse) as illustrated in FIG. 6B. In this manner, the remaining laser-sensitive material 606 can be ablated to increase the depth (d2) of the trench 607 expose one or more embedded features 608. Since the pulse rate is lowered, however, the likelihood of over-heating, damaging and/or deforming the embedded features 608 is reduced or is prevented altogether.

As used herein, the term module refers to a hardware module including an Application Specific Integrated Circuit (ASIC), an electronic circuit, a processor (shared, dedicated, or group) and memory that execute one or more software or firmware programs, a combinational logic circuit, and/or other suitable components that provide the described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the inventive teachings and the practical application, and to enable others of ordinary skill in the art to understand the invention for various embodiments with various modifications as are suited to the particular use contemplated.

The flow diagrams depicted herein are just one example. There may be many variations to this diagram or the operations described therein without departing from the spirit of the invention. For instance, the operations may be performed in a differing order or operations may be added, deleted or modified. All of these variations are considered a part of the claimed invention.

While various embodiments have been described, it will be understood that those skilled in the art, both now and in the future, may make various modifications which fall within the scope of the claims which follow. These claims should be construed to maintain the proper protection for the invention first described.

What is claimed is:

1. A method of ablating an energy-sensitive layer formed on at least one embedded feature of a workpiece, the method comprising:
directing an energy beam generated by an ablation tool to the energy-sensitive layer, the energy beam having an initial fluence and an initial pulse rate;
ablating a first portion of the energy-sensitive layer according to at least one of the initial fluence and the initial pulse rate of the energy beam;
reducing at least one of the initial fluence and the initial pulse rate of the energy beam; and
ablating a second remaining portion of the energy-sensitive layer according to at least one of the reduced fluence and the reduced pulse rate of the energy beam such that the at least one embedded feature is exposed without being damaged or deformed.

2. The method of claim 1, further comprising automatically reducing at least one of the initial fluence and the initial pulse rate of the energy beam in response to ablating the energy-sensitive material to a desired depth.

3. The method of claim 2, further comprising:
determining at least one of a thickness of the energy-sensitive layer and a material of the energy-sensitive layer; and
selecting at least one of the initial fluence and the initial pulse rate based on at least one of the thickness and the material.

4. The method of claim 3 further comprising performing an energy scan across the workpiece to deliver the initial fluence and initial pulse rate to the energy-sensitive layer such that first portion the energy-sensitive layer is ablated.

5. The method of claim 4, further comprising performing a second energy scan across the workpiece to deliver at least one of the reduce fluence and reduce pulse rate to the remaining portion of the energy-sensitive layer such that the at least one embedded feature is exposed without being deformed.

6. The method of claim 5, further comprising:
determining a desired depth at which to ablate the energy-sensitive material;
measuring the initial fluence, and determining an expected depth at which the energy-sensitive material is ablated based on the initial energy depth;
comparing the desired depth to the expected depth; and
adjusting the initial fluence when the expected depth does not match the desired depth.

7. The method of claim 6, wherein the adjusting the initial fluence includes adjusting an attenuator installed on the ablation tool.

8. The method of claim 7, wherein the ablation tool is a laser ablation tool configured to generate a laser beam.

9. An ablation system, comprising:
an ablation tool configured to generate an energy beam to ablate an energy-sensitive material formed on at least one embedded feature of a workpiece,
wherein the ablation tool selects an initial fluence and an initial pulse rate of the energy beam to ablate a first portion of the energy-sensitive layer, and reduces at least one of the initial fluence and the initial pulse rate of the energy beam to ablate a second remaining portion of the energy-sensitive layer such that the at least one embedded feature is exposed without being damaged or deformed.

10. The ablation system of claim 9, wherein the ablation tool automatically reduces at least one of the initial fluence and the initial pulse rate of the energy beam in response to ablating the energy-sensitive material to a desired depth.

11. The ablation system of 10, wherein at least one of the initial fluence and the initial pulse rate is selected based on at least one of the thickness and the material.

12. The ablation system of claim 11, wherein the energy ablation tool performs a first scanning operation that scans the energy beam cross the workpiece to deliver the initial fluence and initial pulse rate to the energy-sensitive layer such that first portion the energy-sensitive layer is ablated.

13. The ablation system of claim 12, wherein the energy ablation tool performs a second scanning operation that scans a second energy scan across the workpiece to deliver at least one of the reduce fluence and reduce pulse rate to the remaining portion of the energy-sensitive layer such that the at least one embedded feature is exposed without being damaged or deformed.

14. The ablation system of claim 13, wherein the energy ablation tool includes an adjustable attenuator configured to vary the fluence of the energy beam.

15. A method of ablating an energy-sensitive layer formed on at least one embedded feature of a workpiece, the method comprising:
generating an energy beam using an ablation tool, the energy beam including a first fluence portion having a first fluence level and a second fluence portion having a second fluence level; and
scanning the energy beam across the energy-sensitive layer such that the first fluence portion ablates the energy-sensitive material to a first depth and the second fluence portion ablates a second remaining portion of the energy-sensitive layer and the at least one embedded feature is exposed without being damaged or deformed.

16. The method of claim 15, wherein the first fluence portion is located between a leading edge of the energy beam and the second fluence portion, and the second fluence portion is located between the first fluence portion and a trailing edge of the energy beam.

17. The method of claim 16, wherein the embedded features is exposed following a single scan of the of the energy beam.

18. The method of claim 17, wherein the first fluence level is greater than the second fluence level.

19. The method of claim 18, further comprising generating the first fluence level and the second fluence level based on at least one of internal optics of the ablation tool and a mask disposed between the ablation tool and the workpiece.

20. The method of claim 19, wherein the first and second fluence levels are selected based on at least one of the thickness of the energy-sensitive layer and the material of the energy sensitive layer.
